(19) United States
(12) Patent Application Publication
(10) Pub. No.: US 2002/0112798 A1
(43) Pub. Date: Aug. 22, 2002

(54) Radial ply tire having a sidewall reinforcement

(75) Inventor: Peter Koch Larsen, Bereldange (LU)

Correspondence Address: The Goodyear Tire & Rubber Company, Intellectual Property Law Department 823, 1144 East Market Street, Akron, OH, 44316-0001, US

(73) Assignee: The Goodyear Tire & Rubber Company

(21) Appl. No.: 10/082,764

(22) Filed: Feb. 25, 2002

Related U.S. Application Data
(63) Continuation of application No. 09/561,132, filed on Apr. 28, 2000.

(51) Int. Cl. B60B 9/18

(52) U.S. Cl. 152/63

(57) ABSTRACT

A pneumatic radial ply tire has an aspect ratio in the range of 0.2 to 0.8, preferably 0.5 to 0.8. The tire has a pair of parallel annular beads, at least two radial carcass plies, at least one radial carcass ply having a pair of turnups being wrapped about said beads. The tire has a belt structure disposed radially outwardly of said radial carcass plies in a crown area of the tire. The belt structure has a width defined as the distance between edges of the belt structure. The tread is disposed radially outward of said belt structure and a sidewall is disposed between the tread and the beads. Each sidewall has a gumstrip interposed between two radial carcass plies extending from below the belt structure radially inward to a radially inner end located at or above the maximum section width of the tire.

### TECHNICAL FIELD

The present invention relates to a radial ply light truck or automobile tire.

### BACKGROUND OF THE INVENTION

In passenger and light truck tires the carcass structure underlying the tread and the belt reinforcements can and does contribute to the overall ride and handling characteristics of the vehicle.

In particular, the sidewalls act like columns in the inflated tire. These structure members transfer loads from the tread and the belt structure up through the sidewall to the rim and ultimately the vehicle suspension.

These sidewalls become a bigger influence on these performance characteristics as the sidewalls get shorter as in very low aspect radial tires used in high performance vehicles, the cornering performance and maneuverability improve sometimes as at loss of ride softness. Alternatively, as the sidewalls lengthened in tire in higher aspect radial tires, the ride can be easily softened but the cornering performance responsiveness is generally lost.

In prior art patent U.S. Pat. No. 5,885,385 issued Mar. 23, 1999, to Noji et al a radial ply passenger tire is shown having a single ply layer extending from bead core to bead core with a turnup end spaced by a bead core and a bead filler. At the radial extremes of the turnup end and radially outward thereof there is an additional rubber reinforcing layer having a 100% modulus at 100° C. of a rubber constituting the reinforcing rubber layer that is not higher than that of the rubber of the belt layers and also has a dynamic elastic modulus at 20° C. of the former rubber in the range of 10 to 40 MPa. This special reinforcing rubber lies to the radially outside portion of the turnup end of ply in the region under the belts to the lower region of the sidewall adjacent the bead portion of the tire. This sidewall rubber reinforcement was tested on tires having a 255/40 ZR17 size. As a result of the test the tire showed improved steering response. In that patent, the further test tire was evaluated in a size 255/50 ZR17 and that test tire the reinforcing layer also had short fibers oriented in various directions within the reinforcing layer. These tires were also tested for ride comfortability and demonstrated in improvement in ride comfort. Evidencing that a tire with a sidewall reinforcement could achieve both an improvement in steering responsiveness and ride comfort.

During the development of runflat tire technology, the use of elastomeric runflat inserts in the sidewall of the tire interposed between carcass ply layers demonstrated an ability to exhibit a tire that could be operated at zero inflation pressure over a limited range. A critical complaint of runflat tires is that the stiffen sidewall structures reduced ride comfort. One noted and unexpected improvement in the runflat tire technology using sidewall inserts, was the steering and cornering responsiveness was dramatically increased by the use of these sidewall load-supporting structures in combination with the pneumatic tire when operated in the inflated condition. The drawback of the prior art inventions has been to develop a pneumatic radial ply tire having the benefits of the runflat tire technology ride, steering response and cornering response without sacrificing the ride comfort capability of the tire.

An object of the present invention is to develop a tire using a limited amount of sidewall reinforcement to enhance the ride performance of the pneumatic tire in terms of steering response and cornering performance without sacrificing ride comfort.

### SUMMARY OF THE INVENTION

A pneumatic radial ply tire has an aspect ratio in the range of 0.2 to 0.8, preferably 0.5 to 0.8. The tire has a pair of parallel annular beads, at least two radial carcass plies, at least one radial carcass ply having a pair of turnups being wrapped about said beads. The tire has a belt structure disposed radially outwardly of said radial carcass plies in a crown area of the tire. The belt structure has a width defined as the distance between edges of the belt structure. The tread is disposed radially outward of said belt structure and a sidewall is disposed between the tread and the beads.

The radial ply tire further has a pair of elastomeric gumstrips interposed between the two plies. Each elastomeric gumstrip has a radially outer end extending from radially inwardly spaced or below each edge of the belt structure to a radially inner end at a radial location at or radially outward of the maximum section width of the tire. The distance between the radially outer end and the radially inner end defines the gumstrip length. Each gumstrip has a cross-sectional average thickness of 2 millimeters or greater, the location of the average thickness extending and being measured over 80% of the gumstrip length. Each gumstrip preferably has a width of at least 50 millimeters. The two plies of the carcass are preferably congruent between the bead to the maximum section width of the tire. Thereafter, the gumstrip is interposed between the two carcass plies and extend radially outward toward the belt reinforcing structure. Most preferably the gumstrips are made of a constant thickness over at least 80% of the gumstrip length. In the preferred embodiment tire the turnups of at least one radial carcass ply extend to a radially outer end, the ends of the turnup being radially outward of the radially inner end of the gumstrip and thus above the radial location of the maximum section width of the tire.

Definitions

“Aspect ratio” of the tire means the ratio of its section height (SH) to its section width (SW) multiplied by 100% for expression as a percentage.

“Axial” and “axially” means lines or directions that are parallel to the axis of rotation of the tire.

“Bead” means that part of the tire comprising an annular tensile member typically attached to or wrapped by ply cords and shaped, with or without other reinforcement elements such as flippers, chippers, apexes, toe guards and chafers, to fit the design rim.

“Belt structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Design rim” means a rim having a specified configuration and width. For the purposes of this Specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Design rim width” means the specified distance axially between rim flanges. For the purpose of this specification, the design rim width (D) is taken as (the minimum recommended rim width plus the maximum recommended rim width)/2 as specified by the appropriate industry standards.

“Equatorial plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Ply” means a continuous layer of rubber-coated parallel cords.

“Radial” and “radially” means directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Section height” (SH) means the radial distance from the nominal rim diameter to the outer diameter of the tire at its equatorial plane.

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sharp diameter” means the diameter as measured radially across the tire through the axis to the points defined by the intersection of a line extending tangent the bead seat and a line extending tangent the bead flange.

“Shoulder” means the upper portion of a sidewall just below the tread edge.

“Sidewall” means that portion of a tire between the tread and the bead.

“Tread width” means the arc length of the tread surface in the axial direction, that is, in a plane passing through the axis of rotation of the tire.

### BRIEF DESCRIPTION OF THE DRAWINGS

FIG. 1 is a cross-sectional view of the tire according to the present invention.

### DETAILED DESCRIPTION OF THE INVENTION

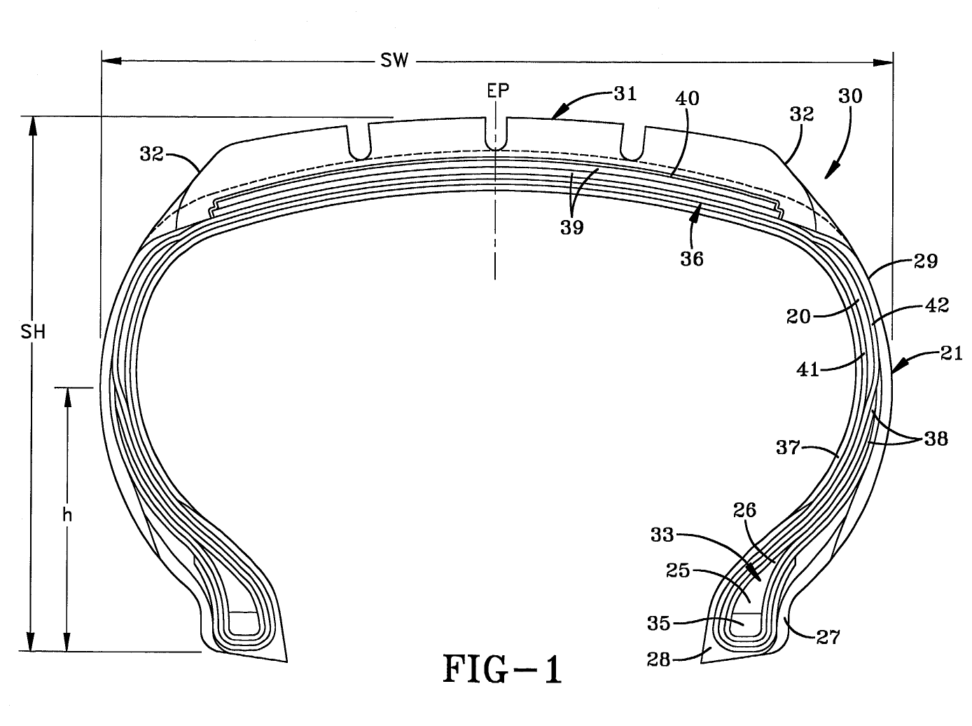

Referring to FIG. 1, there is illustrated a cross-sectional view of a tire made in accordance with the present invention. In the particular embodiment the tire (30) is a radial ply passenger or light truck tire.

The tire (30) is provided with a ground engaging tread portion (31) which terminates in the shoulder portions (32) at the lateral edges of the tread. Radially outer sidewall portions (21) extend from the shoulder portions (32) and terminate in the bead portions (33). Each bead portion has an annular inextensible tensile member (35). The tire (30) is further provided with a carcass reinforcing structure (36) which extends from the tensile member (35) through the sidewall portion (21), the tread portion (31), the opposite sidewall portion (21) down to the opposite tensile member (35). The carcass reinforcing structure (36) has turnup ends (38) which are wrapped about the tensile members (35). The tire (30) may include a conventional innerliner (37) forming the inner peripheral surface of the tire if the tire is to be of the tubeless type.

Placed circumferentially about the radially outer surface of the carcass reinforcing structure (36) beneath the tread portion (31), is a tread reinforcing belt structure (39). In a preferred embodiment the belt structure (39) comprises two single cut belt plies and the cords of the belt plies are oriented at an angle in the range between 17° and 25° with respect to the equatorial plane of the tire. The cords of one ply are disposed in an opposite direction to the equatorial plane from that of the cords of the other belt ply. However, the belt structure (39) may comprise any number of belt plies of any desired configuration and cords may be disposed at any desired angle.

Radially outward of the belt reinforcing structure there may be included an overlay (40). The overlay (40) has cords extending generally circumferentially around the peripheral of the belt reinforcing structure and provides a restriction to circumferential growth at high speeds if employed. The overlay may be comprised of aramid or nylon cords or any other cords suitable for the application including chopped cords or fibers in place of or in addition to continuous cords. The carcass reinforcing structure (36) includes at least two reinforcing plies (41,42). Each ply has a plurality of parallel cords. The cords of the reinforcing plies (41,42) are oriented at an angle of at least 75° with respect to the equatorial plane of the tire (30). The cords reinforcing the carcass ply may be of any material normally used for cord reinforcement of rubber articles, for example, and not by way of limitation, rayon, nylon, polyester, and steel. The reinforcing ply structure (36) has at least one turnup end (38) which wraps about each bead cord (35), and extends to a radially outer end located at about 50%O of the section height of the tire at a radially outer location superior to the radial location (l) of the maximum section width of the tire (30).

Interposed between the ply structure (36) and the turnup (38) is an elastomeric bead filler (25). The bead filler extends radially outward from the radially outer surface of the bead core (35) to an end (26) located preferably at a radial location below the maximum section width of the tire (30).

In the bead portion of the tire the tire may include a fabric chipper (28) a hard elastomeric chafer (27) and cord reinforcement strips such as flipper (not illustrated). Extending radially outward up to the tread (31) is the elastomeric sidewall rubber (29) which is radially outward of the ply structure and its turnup (38).

Interposed between the at least two plies is an elastomeric gumstrip (20) which extends from a location radially below and spaced from each edge of the belt edge structure to a radially inner end at a radial location at or radially outward of the location (l) of the maximum section width of the tire. The distance between the radially outer end and the radially inner end of each gumstrip defines the gumstrip length. This gumstrip is preferably attached to the first carcass ply layer (41) on the tire building drum as the tire (30) is being assembled and precisely located such that when the second ply layer (42) overlays the gumstrip (20), it creates an elastomeric reinforcing structure interposed between the two plies (41,42) that will reside in the upper shoulder region in each of the sidewalls (21) of the tire (30). As illustrated in FIG. 1, the gumstrip (20) preferably has a average maximum thickness of approximately 2 millimeters or greater as measured over 80% of its length between its ends, the ends tapering to a point generally, preferably each gumstrip (20) has a width of at least 50 millimeters or greater depending on the aspect ratio of the tire (30) and the length of the sidewall column to which the gumstrip (20) is being applied. It is believed by placing the gumstrip (20) between the two plies (41,42), the cords of each ply act as a composite structure effectively stiffening the upper sidewall region of the tire (30) similar to that achieved in runflat technology, however, without the necessary additional weight required for the runflat capability at 0 psi. Interestingly by terminating the radially outer end of the gumstrip (20) spaced from the edge of the belt structure (39), this creates a hinge-like effect between the sidewall (21) and the belt structure (39) allowing the tread (31) and belt structure (39) to act as though the sidewalls (21) are generally unreinforced creating a hinge-like action while at the same time enabling the sidewall (21) to be stiffened to enhance its steering, maneuverability and cornering handling characteristics. At the radially inner end it is believed important that the turnup (38) of the ply (41) extend to a location radially outward of the radially inner end of the gumstrip (20). In this application, this means that the turnup end will preferably always be above the radial location (h) of the maximum section width (sw) of the tire (30).

As illustrated the radially inner location of the gumstrip (20) terminates well above the radially outer end of the bead filler (33) insuring that the lower sidewall region of the tire (30) has sufficient flexibility not to influence the ride characteristics of the tire (30). This is an important distinction over the prior art runflat tires wherein the runflat inserts would extend from the belt structure to a position approximately overlapping the radially inner bead filler. This meant that the sidewall along its entire structure basically was stiff thereby enabling the runflat tire to run in the uninflated condition. The tire (30) of the present invention does not provide runflat capability, however, by judiciously spacing the gum strip (20) insert such that it is spaced from the belt reinforcing structure (39) and also spaced from the lower bead filler (25) a insures that the gumstrip (20) only provides the stiffening in the area where the maximum benefit in steering and handling responsiveness can be achieved. Unlike the prior art patent of Noji, the gumstrip (20) of the present invention is a very minor additional weight penalty when compared to the outer reinforcing structure proposed by Noji. In the Noji patent the reinforcing structure extended from under the belt structure to adjacent the bead filler and, therefore, carried a substantial weight penalty with very little benefit in load carrying support, if any. The present invention increases load carrying support of the tire by providing two plies which (41,42) inherently have more strength than a single ply tire, however, in this two ply structure the spacing in the upper sidewall of the gumstrip (20) between the plies (41,42) creates a very enhanced structural performance in this critical area.

Test tires were made in a size 195/70R15C and 225/OR15C whereby the control tires used as a standard wire made using all the same components and materials of the tire according to the present invention excepting the use of the gumstrip (20). As indicated in the table below, the standard tire's performance in stability, cornering, lane change, steering precision all demonstrated marked improvements in each characteristic wherein the tire according to the present invention had a slight dropoff in comfort.

TABLE I

| | | |
|---|---|---|
| Size | 195/70R15C | 225/70R15C |

| Ratings | Control | Test Tire | Control | Test Tire |
|---|---|---|---|---|
| Stability | 4 | 6/8 | 4 | 5 |
| Cornering | 4 | 6/8 | 4 | 6 |
| Lane change | 4 | 6 | 5 | 6/8 |
| Steering | 5 | 8 | 6 | 8 |
| precision | | | | |
| Comfort | 8 | 6 | 8 | 6/8 |

These test tires and the standard tires were all applied to a light truck vehicle requiring an aspect ratio of 70 or greater. What is significant in these types of vehicles is that standard tire constructions may not provide sufficient roll stability in hard cornering maneuvers such that the tire must be stiffened in the upper sidewall region. The present invention provides a way in which the gumstrip (20) is sandwiched between two plies (41,42) making the sidewall (21) a stiffer composite structure in the upper sidewall region which significantly increases the ply bending stiffness. This dramatically increases the roll stability of the vehicle without significantly impacting the weight of the tire.

While the preferred embodiment tire shows the gumstrip having a radially inner end terminating above in radial location of the maximum section width, in some cases it may be desirable to have the radially inner end of the gumstrip extend further toward the bead portion. Nevertheless, it is believed desirable that the radially inner end of the gumstrip terminated significantly above the bead core (35) more preferably, radially above the bead filler if one is used in the construction of the tire.

What is claimed is:

1. A pneumatic radial ply tire having an aspect ratio of 0.2 to 0.8 comprising a pair of parallel annular beads, at least two radial carcass plies, at least one radial carcass ply having a pair of turnups being wrapped around said beads, a belt structure disposed radially outwardly of the radial carcass plies in a crown area of the tire, the belt structure having a width defined as the distance between edges of the belt structure, a tread disposed radially outwardly of the belt structure, and a sidewall disposed between the tread and the beads, the radial ply tire characterized by:
a pair of gumstrips interposed between the two plies, each elastomeric gumstrip having a radially outer end extending from a location axially outwardly and radially inwardly spaced below the edge of the belt structure to a radially inner end at a radial location at or radially outward of the location of the maximum section width of the tire, the distance between the radially outer end and the radially inner end defines the gumstrip length.

2. The pneumatic radial ply tire of claim 1 wherein each gumstrip has a cross-sectional average thickness of 2 mm or greater, the location of the average thickness being measured over 80% of the gumstrip length.

3. The pneumatic radial ply tire of claim 1 wherein each gumstrip has a width of at least 50 mm.

4. The pneumatic radial tire of claim 1 wherein the two plies are concurrent from between the bead to the maximum section width of the tire.

5. The pneumatic radial tire of claim 4, the gumstrips are substantially of a constant thickness over 80% of the gumstrip length.

6. The pneumatic radial ply tire of claim 1 wherein the turnups of the at least one radial carcass ply extends to radially outer ends, the ends of the turnup being radially outward of the radially inner end of the gumstrip.
